(19) United States
(12) Patent Application Publication
(10) Pub. No.: US 2025/0061653 A1
(43) Pub. Date: Feb. 20, 2025

(54) THREE-DIMENSIONAL VESSEL CONSTRUCTION FROM INTRAVASCULAR ULTRASOUND IMAGES

(71) Applicant: Boston Scientific Scimed Inc., Maple Grove, MN (US)

(72) Inventors: Erik Stephen Freed, Maple Grove, MN (US); Sebastian Ordas, Lino Lakes, MN (US); Alexander Shang, Hopkins, MN (US); Wenguang Li, Fremont, CA (US); Alan Torborg, Minneapolis, MN (US)

(73) Assignee: Boston Scientific Scimed Inc., Maple Grove, MN (US)

(21) Appl. No.: 18/797,804

(22) Filed: Aug. 8, 2024

Related U.S. Application Data
(60) Provisional application No. 63/519,380, filed on Aug. 14, 2023.

(51) Int. Cl. G06T 17/00; G06T 7/00; G06T 7/12; G06T 7/13; G06T 7/33; G06T 7/90

(52) U.S. Cl. CPC G06T 17/00; G06T 7/0012; G06T 7/12; G06T 7/13; G06T 7/33; G06T 7/90; G06T 2207/10132; G06T 2207/30096

(57) ABSTRACT

The present disclosure provides to generate a 3D visualization of a vessel from intravascular ultrasound (IVUS) images. In particular, the present disclosure provides to reduce jitter between frames of an IVUS recording to provide a smoother appearance of a longitudinal view of the vessel from the IVUS image frames and to construct a 3D visualization of the vessel from the jitter compensated IVUS image frames.

### CROSS-REFERENCE TO RELATED APPLICATIONS

This application claims the benefit of U.S. Provisional Patent Application Ser. No. 63/519,380 filed on Aug. 14, 2023, the disclosure of which is incorporated herein by reference.

### TECHNICAL FIELD

The present disclosure pertains to generating a three-dimensional (3D) reconstruction of a vessel from intravascular ultrasound (IVUS) images.

### BACKGROUND

Physicians utilize multiple imaging modalities and/or physiological measurements to assess the severity of a stenosis in a blood vessel. For example, a physician will often analyze extravascular images (e.g., angiograms, or the like) as well as intravascular images (e.g., intravascular ultrasound images, optical coherence tomography images, or the like). Further, physicians often consult physiological measurements such as fractional flow reserve when analyzing stenosis severity.

Given the variety and complex nature of the information with which a physician reviews for both pre-treatment planning and post-treatment analysis, graphical interfaces that display this information are often cluttered. Further, the information is often displayed in a two-dimensional (2D) form despite the anatomy being three-dimensional (3D). Accordingly, it can be difficult for untrained persons (e.g., patients, caretakers, procedure decision makers, etc.) to fully appreciate the need and/or benefit of treatment.

Thus, there is a need to provide images or models of vessel anatomy that are more easily interpretable by untrained users.

### BRIEF SUMMARY

The present disclosure provides to generate a 3D visualization of a vessel from intravascular ultrasound (IVUS) images. In particular, the present disclosure provides to reduce jitter between frames of an IVUS recording to provide a smoother appearance of a longitudinal view of the vessel from the IVUS image frames and to construct a 3D visualization of the vessel from the jitter compensated IVUS image frames.

Accordingly, the present disclosure provides a system to generate a 3D reconstruction of a vessel for providing a virtual physiology of the vessel. A physician can use the virtual physiology to provide a more complete understanding a percutaneous coronary intervention (PCI) at both the pre-PCI stage and the post-PCI stage of treatment. This virtual physiology can be shared with untrained users to aid their understanding of the treatment options and results.

[TO BE COMPLETED WHEN CLAIMS ARE FINAL]

### BRIEF DESCRIPTION OF THE SEVERAL VIEWS OF THE DRAWINGS

To easily identify the discussion of any element or act, the most significant digit or digits in a reference number refer to the figure number in which that element is first introduced.

FIG. 1 illustrates an intravascular treatment system in accordance with an embodiment.

FIG. 2 illustrates a routine 200 for predicting vessel compliance in accordance with an embodiment.

FIG. 3 illustrates a routine 300 for predicting vessel compliance in accordance with an embodiment.

FIG. 4 illustrates a routine 400 for predicting vessel compliance in accordance with an embodiment.

FIG. 5A illustrates an aspect of the subject matter in accordance with one embodiment.

FIG. 5B illustrates an aspect of the subject matter in accordance with one embodiment.

FIG. 6A illustrates an aspect of the subject matter in accordance with one embodiment.

FIG. 6B illustrates an aspect of the subject matter in accordance with one embodiment.

FIG. 7A illustrates an exemplary artificial intelligence/machine learning (AI/ML) system suitable for use with exemplary embodiments.

FIG. 7B illustrates an exemplary artificial intelligence/machine learning (AI/ML) system suitable for use with exemplary embodiments.

FIG. 7C illustrates an exemplary artificial intelligence/machine learning (AI/ML) system suitable for use with exemplary embodiments.

FIG. 8 illustrates a computer-readable storage medium 800 in accordance with one embodiment.

FIG. 9A illustrates another intravascular treatment system in accordance with another embodiment.

FIG. 9B illustrates a portion of the intravascular treatment system of FIG. 9A.

FIG. 9C illustrates a portion of the intravascular treatment system of FIG. 9A.

FIG. 10 illustrates a diagrammatic representation of a machine 1000 in the form of a computer system within which a set of instructions may be executed for causing the machine to perform any one or more of the methodologies discussed herein, according to an example embodiment.

### DETAILED DESCRIPTION

As introduced above, in an exemplary embodiment, a system is providing which generates a 3D visualization of a vessel from a series of intravascular ultrasound (IVUS) images. Although the disclosure uses examples of the aortic and coronary arteries, the disclosed system and methods can be implemented to generate a 3D visualization of other types of vessels.

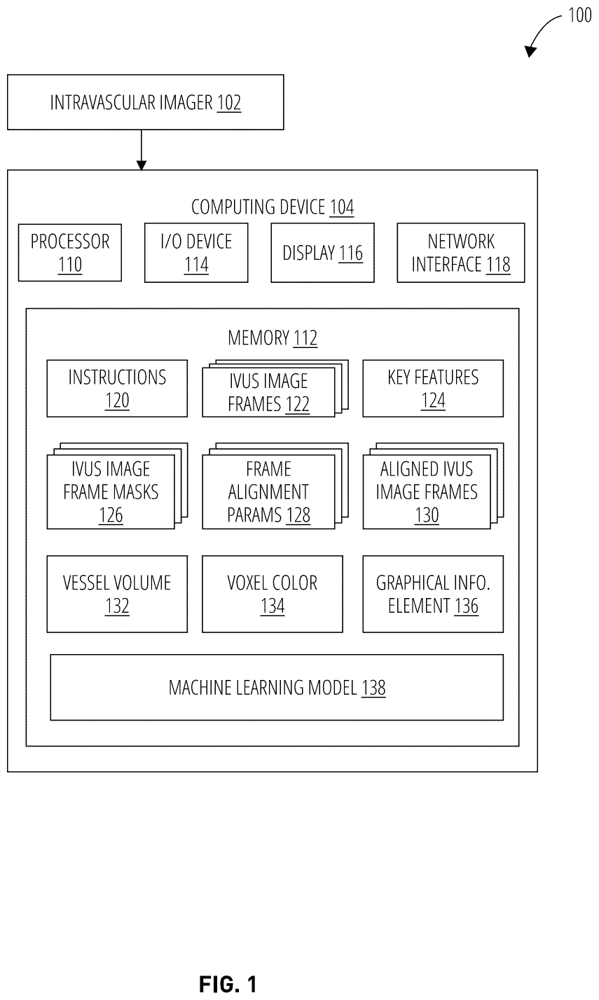

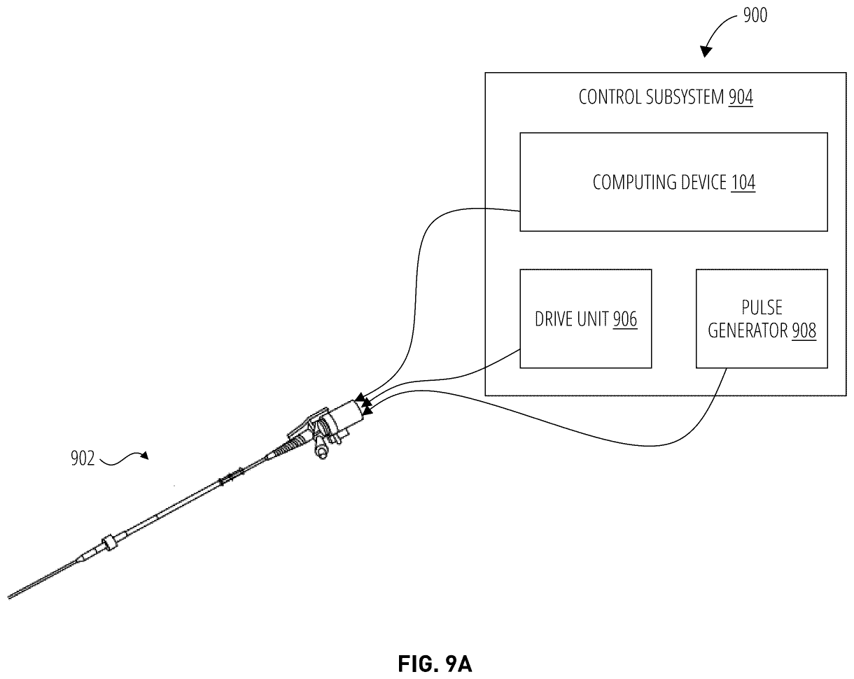

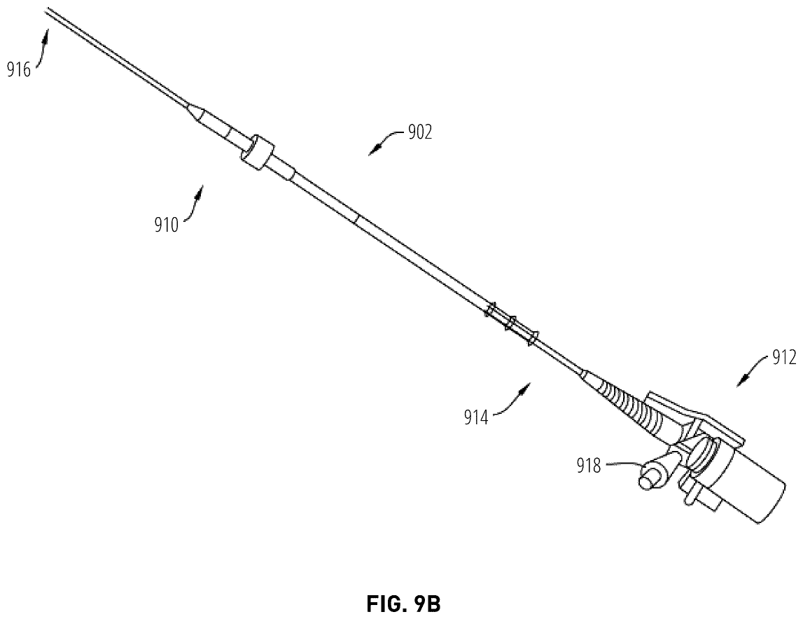

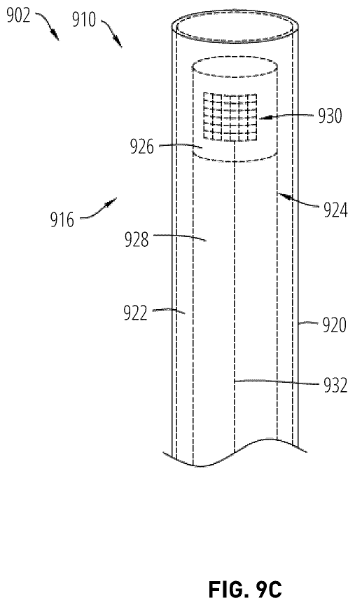

FIG. 1 illustrates a vessel visualization system 100, in accordance with an embodiment of the present disclosure. In general, vessel visualization system 100 is a system for generating a 3D visualization of a vessel based on intravascular images of the vessel. To that end, vessel visualization system 100 includes intravascular imager 102 and computing device 104. Intravascular imager 102 can any of a variety of intravascular imagers (e.g., IVUS, OCT, OCE, or the like). In a specific example, the intravascular imager 102 can be the intravascular treatment system 900 described with reference to FIG. 9A, FIG. 9B, and FIG. 9C below.

Computing device 104 can be any of a variety of computing devices. In some embodiments, computing device 104 can be incorporated into and/or implemented by a console of intravascular imager 102. With some embodiments, computing device 104 can be a workstation or server communicatively coupled to intravascular imager 102. With still other embodiments, computing device 104 can be provided by a cloud based computing device, such as, by a computing as a service system accessibly over a network (e.g., the Internet, an intranet, a wide area network, or the like). Computing device 104 can include processor 110, memory 112, input and/or output (I/O) device 114, and network interface 118.

The processor 110 may include circuitry or processor logic, such as, for example, any of a variety of commercial processors. In some examples, processor 110 may include multiple processors, a multi-threaded processor, a multi-core processor (whether the multiple cores coexist on the same or separate dies), and/or a multi-processor architecture of some other variety by which multiple physically separate processors are in some way linked. Additionally, in some examples, the processor 110 may include graphics processing portions and may include dedicated memory, multiple-threaded processing and/or some other parallel processing capability. In some examples, the processor 110 may be an application specific integrated circuit (ASIC) or a field programmable integrated circuit (FPGA).

The memory 112 may include logic, a portion of which includes arrays of integrated circuits, forming non-volatile memory to persistently store data or a combination of non-volatile memory and volatile memory. It is to be appreciated, that the memory 112 may be based on any of a variety of technologies. In particular, the arrays of integrated circuits included in memory 112 may be arranged to form one or more types of memory, such as, for example, dynamic random access memory (DRAM), NAND memory, NOR memory, or the like.

I/O devices 114 can be any of a variety of devices to receive input and/or provide output. For example, I/O devices 114 can include, a keyboard, a mouse, a joystick, a foot pedal, a haptic feedback device, an LED, or the like. Display 116 can be a conventional display or a touch-enabled display. Further, display 116 can utilize a variety of display technologies, such as, liquid crystal display (LCD), light emitting diode (LED), or organic light emitting diode (OLED), or the like.

Network interface 118 can include logic and/or features to support a communication interface. For example, network interface 118 may include one or more interfaces that operate according to various communication protocols or standards to communicate over direct or network communication links. Direct communications may occur via use of communication protocols or standards described in one or more industry standards (including progenies and variants). For example, network interface 118 may facilitate communication over a bus, such as, for example, peripheral component interconnect express (PCIe), non-volatile memory express (NVMe), universal serial bus (USB), system management bus (SMBus), SAS (e.g., serial attached small computer system interface (SCSI)) interfaces, serial AT attachment (SATA) interfaces, or the like. Additionally, network interface 118 can include logic and/or features to enable communication over a variety of wired or wireless network standards (e.g., 802.11 communication standards). For example, network interface 118 may be arranged to support wired communication protocols or standards, such as, Ethernet, or the like. As another example, network interface 118 may be arranged to support wireless communication protocols or standards, such as, for example, Wi-Fi, Bluetooth, ZigBee, LTE, 5G, or the like.

Memory 112 can include instructions 120, IVUS image frames 122, key features 124, IVUS image frame masks 126, frame alignment parameters 128, aligned IVUS image frames 130, vessel volume 132, voxel color 134, graphical information element 136, and machine learning model 138.

During operation, processor 110 can execute instructions 120 to cause computing device 104 to receive IVUS image frames 122 from intravascular imager 102. In general, IVUS image frames 122 are multi-dimensional multivariate images comprising indications of the vessel type, a lesion in the vessel, the lesion type, stent detection, the lumen border, the lumen dimensions, the minimum lumen area (MLA), the media border (e.g., a media border for media within the blood vessel), the media dimensions, the calcification angle/arc, the calcification coverage, combinations thereof, and/or the like.

Processor 110 can further execute instructions 120 to cause computing device 104 to determine key features 124 from IVUS image frames 122. For example, processor 110 can execute instructions 120 to automatically determine the lumen area at various points along the vessel from IVUS image frames 122. As another example, processor 110 can execute instructions 120 to automatically determine the vessel border at various points along the vessel from IVUS image frames 122. As another example, processor 110 can execute instructions 120 to automatically determine the plaque burden of the vessel at various points along the vessel from IVUS image frames 122. These are just a few examples of assessments that can be represented in key features 124. Other examples can include calcium burden, side branches, etc. With some embodiments, the key features 124 can be inferred from machine learning model 138. For example, processor 110 can execute machine learning model 138 to infer key features 124 (e.g., borders, plaque burden, etc.) from IVUS image frames 122.

Processor 110 can further execute instructions 120 to cause computing device 104 to generate IVUS image frame masks 126 from IVUS image frames 122 and key features 124. For example, processor 110 can execute instructions 120 to generate, for each frame of IVUS image frames 122, a mask comprising an indication of the key features 124 (e.g., lumen border, vessel border, plaque burden, etc.) With some embodiments, processor 110 can execute machine learning model 138 to infer IVUS image frame masks 126 from IVUS image frames 122 and key features 124. In other embodiments, processor 110 can execute machine learning model 138 to infer IVUS image frame masks 126 from IVUS image frames 122 only.

Processor 110 can further execute 120 to cause computing device 104 to generate frame alignment parameters 128 from IVUS image frames 122 and IVUS image frame masks 126. For example, processor 110 can execute instructions 120 to cause computing device 104 to implement a self-registration algorithm that takes IVUS image frame masks 126 and derives a frame alignment parameters 128 for each frame to produce a best-fit 3D model when the frames are stacked together. These adjustments may include but are not limited to affine transforms (such as translation, rotation, and area-preserving skewing) and B-spline transforms. These adjustments filter out transients (e.g., catheter jostling, vessel deformation between heart beats, etc.) while preserving the integrity of key metrics (e.g., lumen/vessel area, average diameter, stenosis and plaque burden).

Processor 110 can further execute instructions 120 to cause computing device 104 to re-sample and/or align the IVUS image frames 122 using frame alignment parameters 128, thereby generating aligned IVUS image frames 130. For example, the position of each frame of IVUS image frames 122 (e.g., relative to adjacent frames, relative to a fixed reference, or the like) can be adjusted based on frame alignment parameters 128 to generate aligned IVUS image frames 130.

Processor 110 can further execute instructions 120 to cause computing device 104 to generate vessel volume 132 from aligned IVUS image frames 130. For example, the frames of aligned IVUS image frames 130 can be stacked to form a 3D volume of the vessel, which can be represented by vessel volume 132.

Processor 110 can further execute instructions 120 to cause computing device 104 to determine a color for each voxels (e.g., pixels) of vessel volume 132 based on key features 124, where the color can be indicative of a key feature. For example, heathy vessel borders can be assigned a first color (e.g., brown, or the like), calcified plaque can be assigned a second color (e.g., gray, or the like), uncalcified plaque can be assigned a third color (e.g., yellow, or the like), lumen borders can be assigned a fourth color (e.g., transparent, or the like), and a stent can be assigned a fifth color (e.g., white, or the like). In such a manner, the vessel volume 132 can be rendered in a manner that is indicative of the key features 124.

Additionally, in some embodiments, processor 110 can execute instructions 120 to generate a graphical information element 136 comprising indications of vessel volume 132 and cause the graphical information element 136 to be displayed for a user on display 116. For example, processor 110 can execute instructions 120 to render the vessel volume 132 as a 3D volume using voxel color 134 and generate a graphical user interface (GUI) comprising indications of the rendered 3D volume.

With some embodiments, processor 110 can execute instructions 120 to provide a GUI in which a user can interact with the 3D model in real-time, thereby providing a comprehensive view of the vessel. Processor 110 can execute instructions 120 to provide various interactions, including rotation, zooming in/out, panning, fly-through animation, making cut-away views, showing/hiding certain detected features, making area or distance measurements, and marking/labelling locations on the 3D volume.

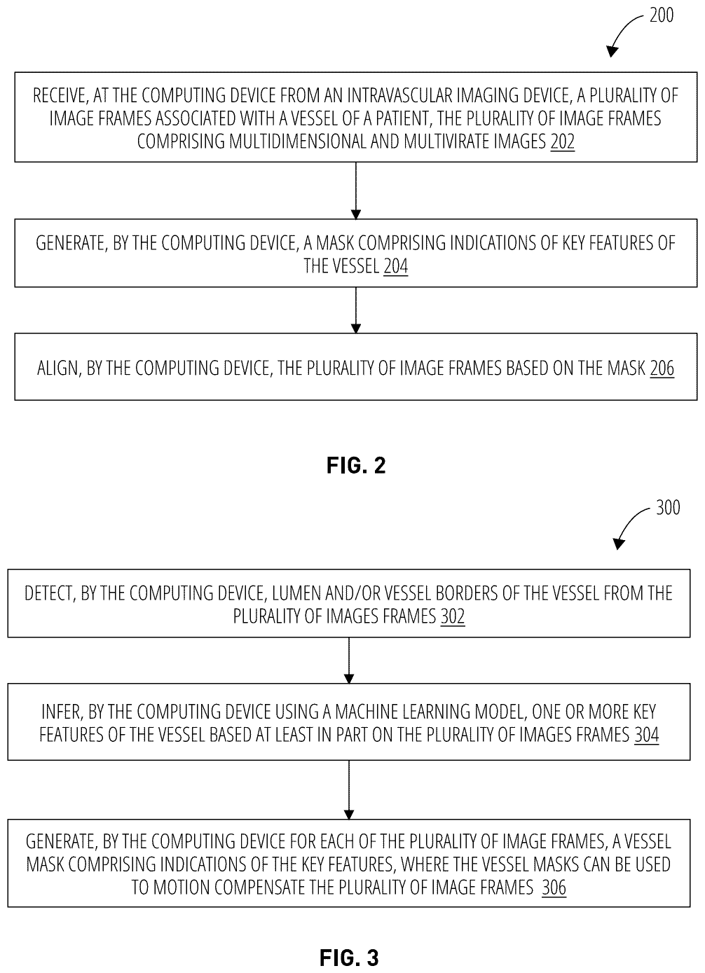

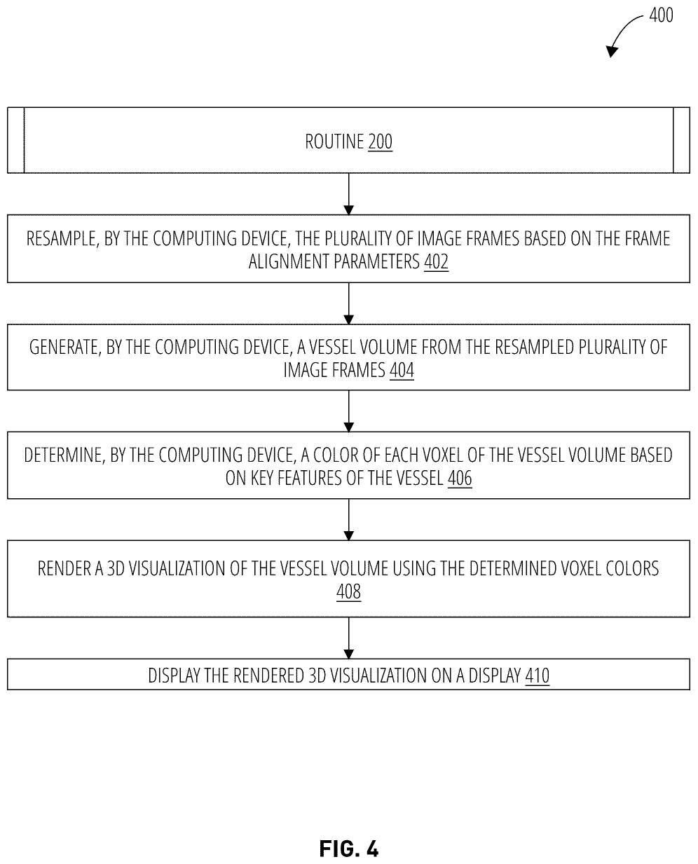

FIG. 2, FIG. 3, and FIG. 4 illustrate routines 200, 300 and 400, respectively, according to some embodiments of the present disclosure. Routines 200, 400 and 300 can be implemented by vessel visualization system 100 or another computing device as outlined herein to provide a 3D visualization of a vessel from a series of intravascular images (e.g., IVUS images, or the like). Routine 200 can be implemented to align image frames from a series of image frames of a vessel (e.g., an IVUS run, or the like) while routine 400 can be implemented to generate a visualization of the vessel from the aligned image frames. Routine 300 can be implemented to generate a mask comprising indications of key features represented in each frame of the IVUS images.

Routine 200 can begin at block 202 “receive, at the computing device from an intravascular imaging device, a plurality of image frames associated with a vessel of a patient, the plurality of image frames comprising multidimensional and multivirate images” computing device 104 of vessel visualization system 100 receives IVUS image frames 122 from intravascular imager 102 where IVUS image frames 122 are multidimensional and multivirate images of the vessel. For example, processor 110 can execute instructions 120 to receive data including indications of IVUS image frames 122 from intravascular imager 102 via network interface 118.

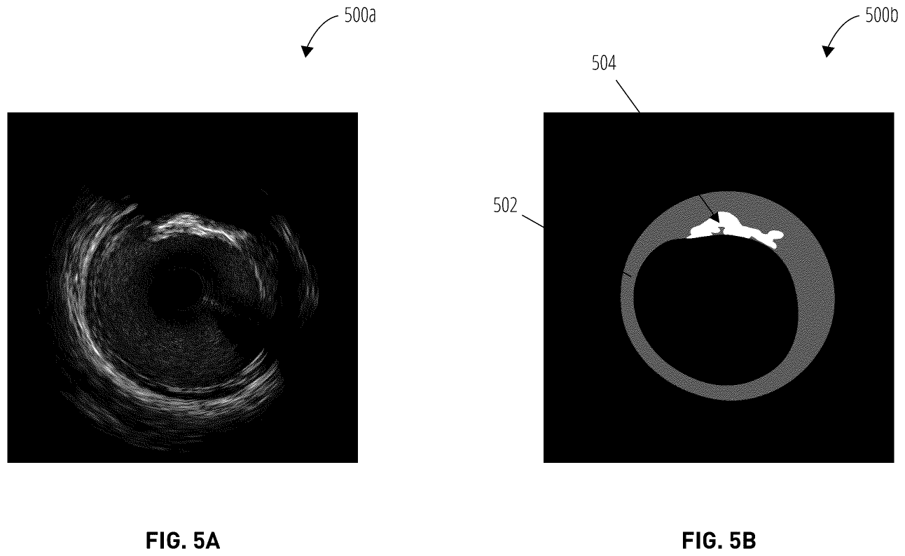

Continuing to block 204 “generate, by the computing device, a mask comprising indications of key features of the vessel” a mask comprising indications of key features of the vessel, for each of the plurality of image frames, can be generated from the plurality of image frames received at block 202. For example, processor 110 can execute instructions 120 to generate IVUS image frame masks 126 from IVUS image frames 122. As outlined above, IVUS image frame masks 126 can include indications of vessel borders, lumen borders, plaque morphology, and/or etc. of the vessel. An example of a frame from IVUS image frames 122 and an associated mask of IVUS image frame masks 126, which can be generated as outlined herein is given in FIG. 5A and FIG. 5B, described in more detail below.

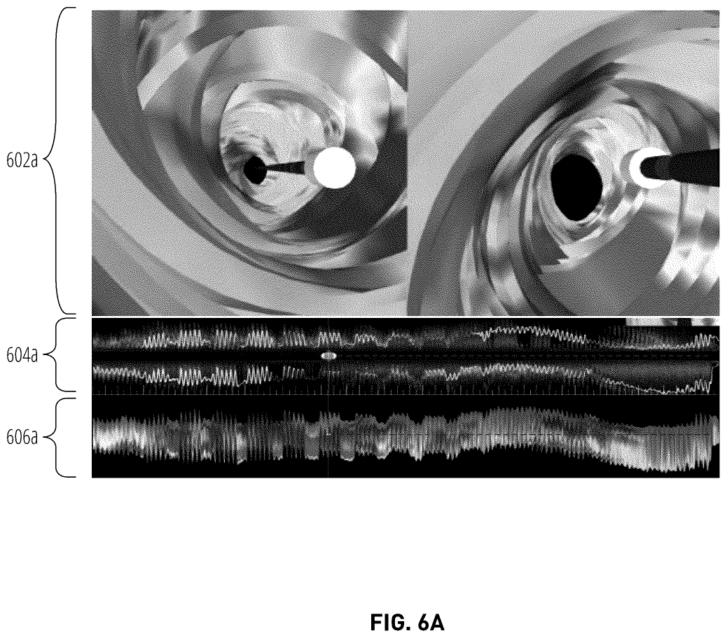

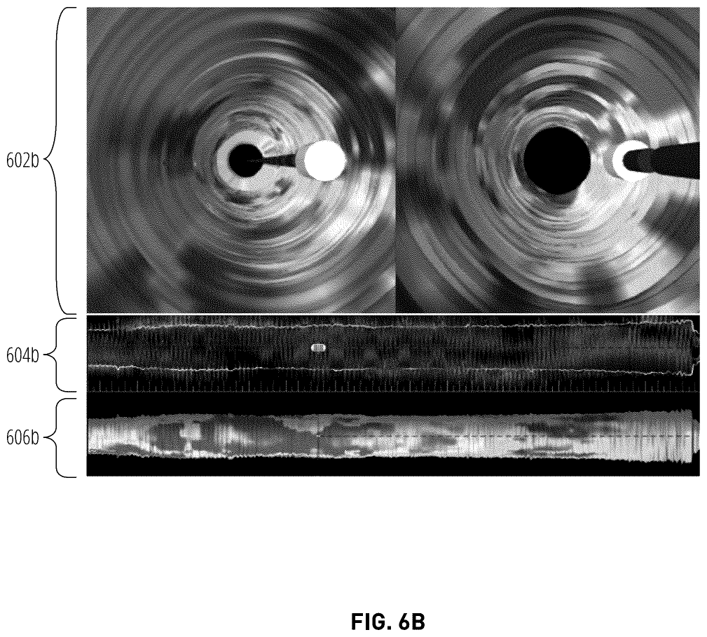

Continuing to block 206 “align, by the computing device, the plurality of image frames based on the mask” the plurality of image frames received at block 202 can be aligned based on the mask generated at block 204. For example, processor 110 can execute instructions 120 to align (e.g., self-register, or the like) the IVUS image frames 122 based on the IVUS image frame masks 126. As a specific example, processor 110 can execute instructions 120 to determine frame alignment parameters 128 from IVUS image frames 122 and IVUS image frame masks 126 and generate aligned IVUS image frames 130 from IVUS image frames 122 and frame alignment parameters 128. An example of unaligned IVUS frames (e.g., IVUS image frames 122) and aligned IVUS frames (e.g., aligned IVUS image frames 130), which can be generated as outlined herein is given in FIG. 6A and FIG. 6B, described in more detail below.

As noted, FIG. 3 illustrates routine 300, which can be implemented to generate a mask comprising indications of key features represented in each frame of the IVUS images. With some embodiments, routine 300 can be implemented at block 204 of routine 200. routine 300 can begin at block 302. At block 302 “detect, by the computing device, lumen and/or vessel borders of the vessel from the plurality of images frames” lumen and vessel borders of the vessel can be detected from the plurality of image frames received at block 202. For example, processor 110 can execute instructions 120 to detect the borders of the vessel and the lumen. In a specific example, processor 110 can execute instructions 120 to segment the image frames and detect the borders based on the segmented image frames.

Continuing to block 304 “infer, by the computing device using a machine learning model, one or more key features of the vessel based at least in part on the plurality of images frames” key features of the vessel can be inferred by a machine learning (ML) model. For example, processor 110 can execute instructions 120 to infer the plaque burden from IVUS image frames 122. Indications of the inferred plaque burden can be stored as key features 124.

Continuing to block 306 “generate, by the computing device for each of the plurality of image frames, a vessel mask comprising indications of the key features, where the vessel masks can be used to motion compensate the plurality of image frames” masks for each of the image frames can be generated comprising an indication of just the key features of the IVUS image frames. For example, processor 110 can execute instructions 120 to generate IVUS image frame masks 126 from IVUS image frames 122 and key features 124.

As noted, FIG. 4 illustrates routine 400, which can be implemented to generate a visualization of a vessel from aligned IVUS images. Routine 400 can begin with routine 200. From routine 200, routine 400 can continue to block 402. At block 402 “resample, by the computing device, the plurality of image frames based on the frame alignment parameters” the plurality of image frames (e.g., received at block 202) can be resampled based on the frame alignment parameters generated at block 206. For example, processor 110 can execute instructions 120 to generate aligned IVUS image frames 130 by resampling IVUS image frames 122 using frame alignment parameters 128.

Continuing to block 404 “generate, by the computing device, a vessel volume from the resampled plurality of image frames” a volume of the vessel can be generated from the resampled and aligned image frames. For example, processor 110 can execute instructions 120 to generate vessel volume 132 from aligned IVUS image frames 130. As a specific example, processor 110 can execute instructions 120 to stack aligned IVUS image frames 130 to generate vessel volume 132.

Continuing to block 406 “determine, by the computing device, a color of each voxel of the vessel volume based on key features of the vessel” a color for each voxel (e.g., pixel) of the vessel volume can be determined based on key features of the vessel. For example, processor 110 can execute instructions 120 to determine voxel color 134 for each pixel of vessel volume 132 from key features 124. In general, each type of key features of key features 124 can be assigned a particular color and each pixel of vessel volume 132 can be assigned the color for the type of key features for which that pixel represents.

Continuing to block 408 “render a 3D visualization of the vessel volume using the determined voxel colors” a 3D visualization of the vessel volume can be generated based on the vessel volume and the determined colors. For example, processor 110 can execute instructions 120 to render a 3D visualization of the vessel volume 132 using voxel colors 134.

Continuing to block 410 “display the rendered 3D visualization on a display” the rendered 3D visualization can be displayed on a display. For example, processor 110 can execute instructions 120 to generate a graphical information element comprising an indication of rendered 3D visualization and display the graphical information element on a display (e.g., display 116, or the like).

FIG. 5A and FIG. 5B depict examples of a frame of a series of IVUS images and a corresponding mask. As outlined above, the present disclosure provides to generate a mask for each frame of a series of IVUS image frames and to align the IVUS image frames based on the masks. Turning to FIG. 5A, an IVUS image frame 500a is depicted. As discussed above vessel visualization system 100 can execute instructions 120 to receive IVUS image frame 500a (or information elements and/or data structures comprising indications of IVUS image frame 500a) at block 202. More particularly as will be appreciated, several frames (like IVUS image frame 500a) can be received as ultrasound images are captured by a probe while it is pulled back through a vessel.

FIG. 5B depicts an image frame mask 500b associated with IVUS image frame 500a depicting only the key features, such as borders 502 (e.g., vessel and lumen borders, etc.) and plaque 504. With some embodiments (e.g., as described above) image frame mask 500b can be generated based on first detecting the borders 502 and second detecting plaque and/or other key features. In other embodiments, a machine learning model (e.g., machine learning model 138, or the like) can be used to infer image frame mask 500b from IVUS image frame 500a.

FIG. 6A illustrates various views of IVUS image frames 122, including an on-axis view 602a, a longitudinal view 604a and a fly through view 606a. As can be seen from this figure, the views 602a, 604a and 606a highlight that there is movement between frames in the IVUS image frames 122. As described above, this movement can be due to patient movement, heartbeat, blood flow, catheter movement, etc. However, to provide a more realistic view of the vessel, the present disclosure provides to align the frames as described above.

FIG. 6B illustrates various views of aligned IVUS image frames 130, including an aligned on-axis view 602b, an aligned longitudinal view 604b and an aligned fly through view 606b. As can be seen from this figure, the views 602b, 604b and 606b depict a smoother transition between frames versus the views shown in FIG. 6A. Accordingly, a more realistic vessel volume 132 can be generated from the aligned IVUS image frames 130 and presented to a user as contemplated herein.

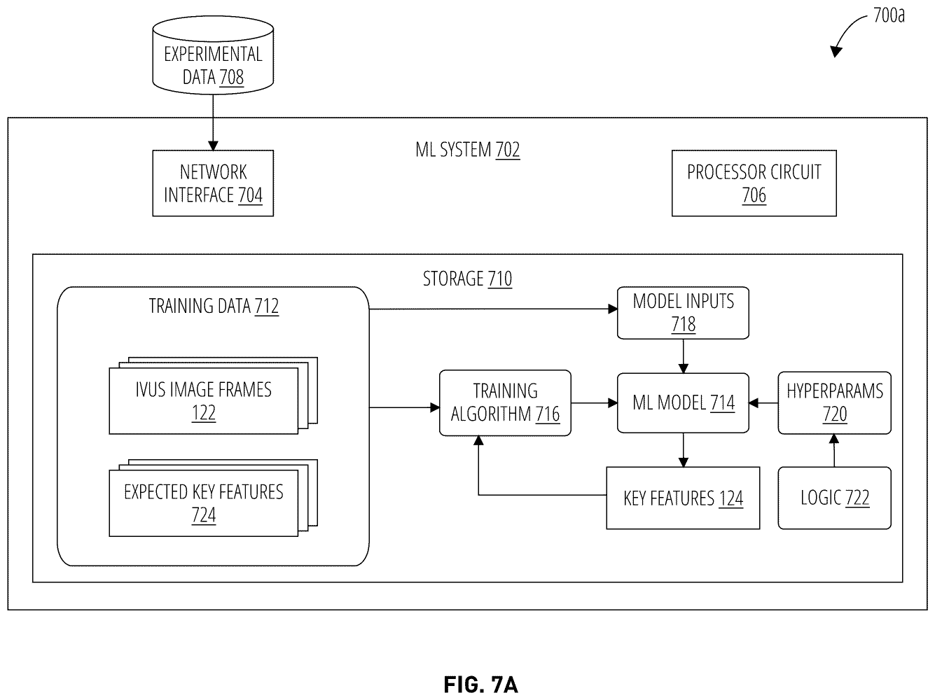

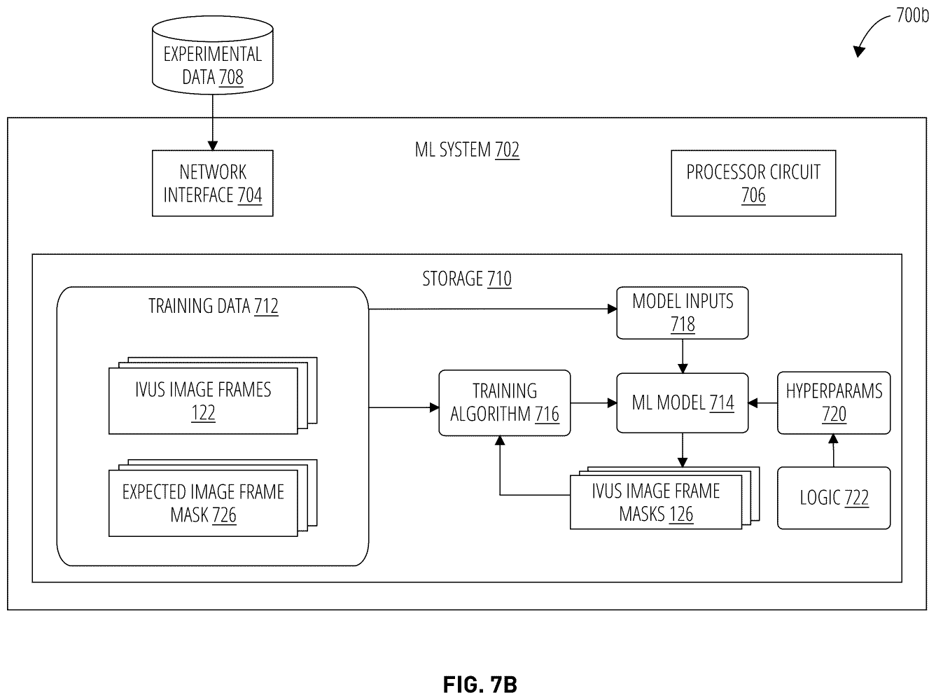

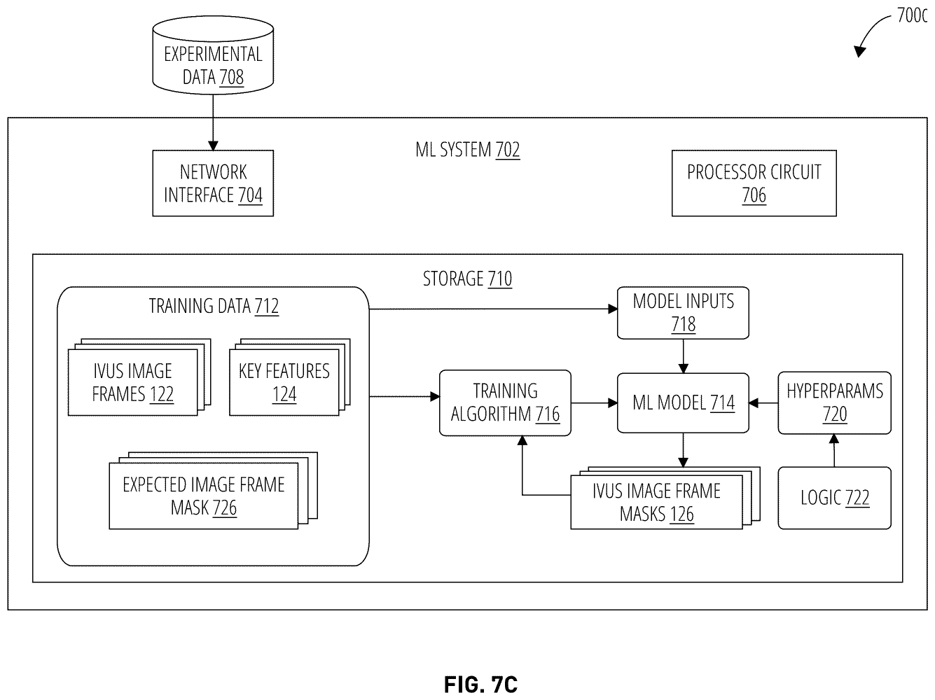

As noted, with some embodiments, a machine learning (ML) model can be utilized to infer key features and/or a mask. For example, processor 110 of computing device 104 can execute instructions 120 to infer key features 124 from IVUS image frames 122 using machine learning model 138. As another example, processor 110 of computing device 104 can execute instructions 120 to infer IVUS image frame masks 126 from IVUS image frames 122 (or IVUS image frames 122 and key features 124) using machine learning model 138. In such examples, the ML model (e.g., machine learning model 138) can be stored in memory 112 of computing device 104. It will be appreciated however, that prior to being deployed, the ML model is to be trained. FIG. 7A illustrates ML training environment 700a, which can be used to train an ML model that may later be used to generate (or infer) key features 124 as described herein. The ML training environment 700a may include an ML system 702, such as a computing device that applies an ML algorithm to learn relationships. In this example, the ML algorithm can learn relationships between a set of inputs (e.g., IVUS image frames 122) and an output (e.g., key features 124).

The ML system 702 may make use of experimental data 708 gathered during several prior procedures. Experimental data 708 can include IVUS image frames 122 for several patients, or rather, several IVUS runs through different vessels. The experimental data 708 may be collocated with the ML system 702 (e.g., stored in a storage 710 of the ML system 702), may be remote from the ML system 702 and accessed via a network interface 704, or may be a combination of local and remote data.

Experimental data 708 can be used to form training data 712. As noted above, the ML system 702 may include a storage 710, which may include a hard drive, solid state storage, and/or random access memory. The storage 710 may hold training data 712. In general, training data 712 can include information elements or data structures comprising indications of an IVUS image frames 122 and associated expected key features for several patients. With some embodiments, experimental data 708 includes just the IVUS image frames 122 for the patients and ML system 702 is configured (e.g., with processor and instructions executable by the processor) to generate and/or receive expected key features 724 for IVUS image frames 122 of each patient represented in experimental data 708.

The training data 712 may be applied to train an ML model 714. Depending on the application, different types of models may be used to form the basis of ML model 714. For instance, in the present example, an artificial neural network (ANN) may be particularly well-suited to learning associations between IVUS image frames (e.g., IVUS image frames 122) and key features (e.g., key features 124). Convoluted neural networks may also be well-suited to this task. Any suitable training algorithm 716 may be used to train the ML model 714. Nonetheless, the example depicted in FIG. 7A may be particularly well-suited to a supervised training algorithm or reinforcement learning training algorithm. For a supervised training algorithm, the ML system 702 may apply the IVUS image frames 122 as model inputs 718, to which expected key features 724 may be mapped to learn associations between the IVUS image frames 122 and the key features 124. In a reinforcement learning scenario, training algorithm 716 may attempt to maximize some or all (or a weighted combination) of the model inputs 718 mappings to key features 124 to produce ML model 714 having the least error. With some embodiments, training data 712 can be split into “training” and “testing” data wherein some subset of the training data 712 can be used to adjust the ML model 714 (e.g., internal weights of the model, or the like) while another, non-overlapping subset of the training data 712 can be used to measure an accuracy of the ML model 714 to infer (or generalize) key features 124 from “unseen” training data 712 (e.g., training data 712 not used to train ML model 714).

The ML model 714 may be applied using a processor circuit 706, which may include suitable hardware processing resources that operate on the logic and structures in the storage 710. The training algorithm 716 and/or the development of the trained ML model 714 may be at least partially dependent on hyperparameters 720. In exemplary embodiments, the model hyperparameters 720 may be automatically selected based on hyperparameter optimization logic 722, which may include any known hyperparameter optimization techniques as appropriate to the ML model 714 selected and the training algorithm 716 to be used. In optional, embodiments, the ML model 714 may be re-trained over time, to accommodate new knowledge and/or updated experimental data 708.

Once the ML model 714 is trained, it may be applied (e.g., by the processor circuit 706, by processor 110, or the like) to new input data (e.g., IVUS image frames 122 captured during a pre-PCI intervention, a post-PCI intervention, or the like). This input to the ML model 714 may be formatted according to a predefined model inputs 718 mirroring the way that the training data 712 was provided to the ML model 714. The ML model 714 may generate key features 124 which may, for example, include indications of lumen and vessel borders, plaque burden, etc. represented in IVUS image frames 122 provided as input to the ML model 714.

The above description pertains to a particular kind of ML system 702, which applies supervised learning techniques given available training data with input/result pairs. However, the present invention is not limited to use with a specific ML paradigm, and other types of ML techniques may be used. For example, in some embodiments the ML system 702 may apply for example, evolutionary algorithms, or other types of ML algorithms and models to generate key features 124 from IVUS image frames 122.

In some examples, an ML model can be utilized to infer a mask from IVUS image frames. FIG. 7B illustrates ML training environment 700b, which is an example of ML training environment 700a configured to train ML model 714 to infer IVUS image frame masks 126 from IVUS image frames 122. As such, training data 712 can include IVUS image frames 122 and expected image frame mask 726 while ML model 714 can be “trained” as outlined above to infer 126 from IVUS image frames 122.

In some examples, an ML model can be utilized to infer a mask from IVUS image frames and key features. In such an example, key features can be generated from an ML model or from another algorithm (e.g., a segmentation algorithm, or the like). FIG. 7C illustrates ML training environment 700c, which is an example of ML training environment 700a configured to train ML model 714 to infer IVUS image frame masks 126 from IVUS image frames 122 and key features 124. As such, training data 712 can include IVUS image frames 122 and key features 124 as well as expected image frame mask 726 while ML model 714 can be “trained” as outlined above to infer 126 from IVUS image frames 122 and key features 124.

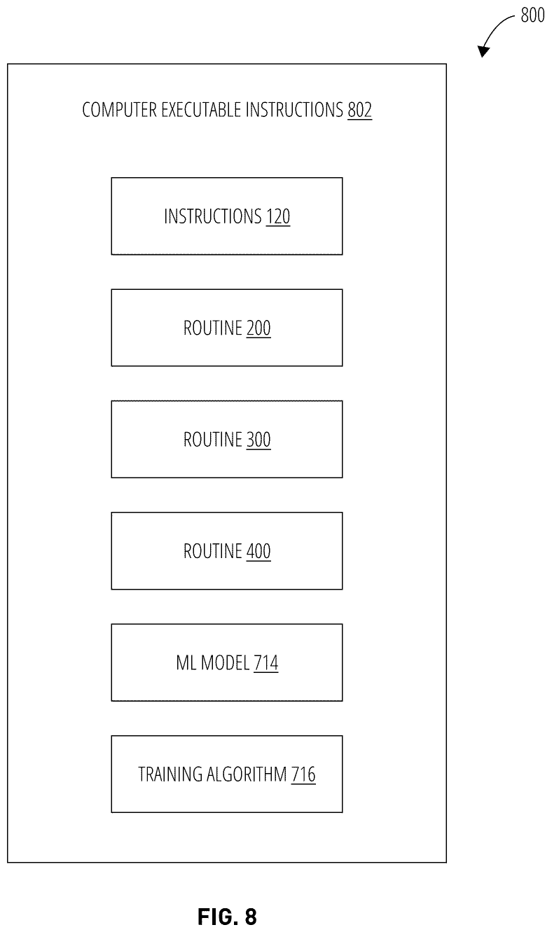

FIG. 8 illustrates computer-readable storage medium 800. Computer-readable storage medium 800 may comprise any non-transitory computer-readable storage medium or machine-readable storage medium, such as an optical, magnetic or semiconductor storage medium. In various embodiments, computer-readable storage medium 800 may comprise an article of manufacture. In some embodiments, computer-readable storage medium 800 may store computer executable instructions 802 with which circuitry (e.g., processor 110, or the like) can execute. For example, computer executable instructions 802 can include instructions to implement operations described with respect to routine 200, which can be specially programmed to cause vessel visualization system 100 to perform the operations described with reference to routine 200 of FIG. 2, routine 300 of FIG. 3, or routine 400 of FIG. 4. As another example, computer executable instructions 802 can include instructions 120, ML model 714, and/or training algorithm 716. Examples of computer-readable storage medium 800 or machine-readable storage medium may include any tangible media capable of storing electronic data, including volatile memory or non-volatile memory, removable or non-removable memory, erasable or non-erasable memory, writeable or re-writeable memory, and so forth. Examples of computer executable instructions 802 may include any suitable type of code, such as source code, compiled code, interpreted code, executable code, static code, dynamic code, object-oriented code, visual code, and the like.

FIG. 9A, FIG. 9B, and FIG. 9C illustrate an example intravascular treatment system 900 and are described together herein. FIG. 9A is a component level view while FIG. 9B and FIG. 9C are side and perspective views, respectively, of a portion of the intravascular treatment system 900 of FIG. 9A. The intravascular treatment system 900 takes the form of an IVUS imaging system and can be implemented as part of the vessel visualization system 100 of FIG. 1. The intravascular treatment system 900 includes a catheter 902 and a control subsystem 904. The control subsystem 904 includes the computing device 104, a drive unit 906 and a pulse generator 908. The catheter 902 and control subsystem 904 are operably coupled, or more specifically, the catheter 902 is electrically and/or mechanically coupled to the computing device 104, drive unit 906, and pulse generator 908 such that signals (e.g., control, measurement, image data, or the like) can be communicated between the catheter 902 and control subsystem 904.

It is noted that the computing device 104 includes display 116. However, in some applications, display 116 may be provided as a separate unit from computing device 104, for example, in a different housing, or the like. In some instances, the pulse generator 908 forms electric pulses that may be input to one or more transducers 930 disposed in the catheter 902.

In some instances, mechanical energy from the drive unit 906 may be used to drive an imaging core 924 disposed in the catheter 902. In some instances, electric signals transmitted from the one or more transducers 930 may be input to the processor 110 of computing device 104 for processing as outlined here. For example, to be used to generate vessel volume 132 and graphical information element 136. In some instances, the processed electric signals from the one or more transducers 930 can also be displayed as one or more images on the display 116.

In some instances, the processor 110 may also be used to control the functioning of one or more of the other components of control subsystem 904. For example, the processor 110 may be used to control at least one of the frequency or duration of the electrical pulses transmitted from the pulse generator 908, the rotation rate of the imaging core 924 by the drive unit 906, the velocity or length of the pullback of the imaging core 924 by the drive unit 906, or one or more properties of one or more images formed on the display 116, such as, the vessel volume 132 and graphical information element 136.

FIG. 9B is a side view of one embodiment of the catheter 902 of the intravascular treatment system 900 of FIG. 9A. The catheter 902 includes an elongated member 910 and a hub 912. The elongated member 910 includes a proximal end 914 and a distal end 916. In FIG. 9B, the proximal end 914 of the elongated member 910 is coupled to the catheter hub 912 and the distal end 916 of the elongated member 910 is configured and arranged for percutaneous insertion into a patient. Optionally, the catheter 902 may define at least one flush port, such as flush port 918. The flush port 918 may be defined in the hub 912. The hub 912 may be configured and arranged to couple to the control subsystem 904 of intravascular treatment system 900. In some instances, the elongated member 910 and the hub 912 are formed as a unitary body. In other instances, the elongated member 910 and the catheter hub 912 are formed separately and subsequently assembled.

FIG. 9C is a perspective view of one embodiment of the distal end 916 of the elongated member 910 of the catheter 902. The elongated member 910 includes a sheath 920 with a longitudinal axis (e.g., a central longitudinal axis extending axially through the center of the sheath 920 and/or the catheter 902) and a lumen 922. An imaging core 924 is disposed in the lumen 922. The imaging core 924 includes an imaging device 926 coupled to a distal end of a driveshaft 928 that is rotatable either manually or using a computer-controlled drive mechanism. One or more transducers 930 may be mounted to the imaging device 926 and employed to transmit and receive acoustic signals. The sheath 920 may be formed from any flexible, biocompatible material suitable for insertion into a patient. Examples of suitable materials include, for example, polyethylene, polyurethane, plastic, spiral-cut stainless steel, nitinol hypotube, and the like or combinations thereof.

In some instances, for example as shown in these figures, an array of transducers 930 are mounted to the imaging device 926. Alternatively, a single transducer may be employed. Any suitable number of transducers 930 can be used. For example, there can be two, three, four, five, six, seven, eight, nine, ten, twelve, fifteen, sixteen, twenty, twenty-five, fifty, one hundred, five hundred, one thousand, or more transducers. As will be recognized, other numbers of transducers may also be used. When a plurality of transducers 930 are employed, the transducers 930 can be configured into any suitable arrangement including, for example, an annular arrangement, a rectangular arrangement, or the like.

The one or more transducers 930 may be formed from materials capable of transforming applied electrical pulses to pressure distortions on the surface of the one or more transducers 930, and vice versa. Examples of suitable materials include piezoelectric ceramic materials, piezocomposite materials, piezoelectric plastics, barium titanates, lead zirconate titanates, lead metaniobates, polyvinylidene fluorides, and the like. Other transducer technologies include composite materials, single-crystal composites, and semiconductor devices (e.g., capacitive micromachined ultrasound transducers (“cMUT”), piezoelectric micromachined ultrasound transducers (“pMUT”), or the like).

The pressure distortions on the surface of the one or more transducers 930 form acoustic pulses of a frequency based on the resonant frequencies of the one or more transducers 930. The resonant frequencies of the one or more transducers 930 may be affected by the size, shape, and material used to form the one or more transducers 930. The one or more transducers 930 may be formed in any shape suitable for positioning within the catheter 902 and for propagating acoustic pulses of a desired frequency in one or more selected directions. For example, transducers may be disc-shaped, block-shaped, rectangular-shaped, oval-shaped, and the like. The one or more transducers may be formed in the desired shape by any process including, for example, dicing, dice and fill, machining, microfabrication, and the like.

As an example, each of the one or more transducers 930 may include a layer of piezoelectric material sandwiched between a matching layer and a conductive backing material formed from an acoustically absorbent material (e.g., an epoxy substrate with tungsten particles). During operation, the piezoelectric layer may be electrically excited to cause the emission of acoustic pulses.

The one or more transducers 930 can be used to form a radial cross-sectional image of a surrounding space. Thus, for example, when the one or more transducers 930 are disposed in the catheter 902 and inserted into a blood vessel of a patient, the one more transducers 930 may be used to form an image of the walls of the blood vessel and tissue surrounding the blood vessel.

The imaging core 924 is rotated about the longitudinal axis of the catheter 902. As the imaging core 924 rotates, the one or more transducers 930 emit acoustic signals in different radial directions (e.g., along different radial scan lines). For example, the one or more transducers 930 can emit acoustic signals at regular (or irregular) increments, such as 256 radial scan lines per revolution, or the like. It will be understood that other numbers of radial scan lines can be emitted per revolution, instead.

When an emitted acoustic pulse with sufficient energy encounters one or more medium boundaries, such as one or more tissue boundaries, a portion of the emitted acoustic pulse is reflected to the emitting transducer as an echo pulse. Each echo pulse that reaches a transducer with sufficient energy to be detected is transformed to an electrical signal in the receiving transducer. The one or more transformed electrical signals are transmitted to the processor 110 of the computing device 104 where it is processed to form IVUS image frames 122 and subsequently generate vessel volume 132 and graphical information element 136 to be displayed on display 116. In some instances, the rotation of the imaging core 924 is driven by the drive unit 906, which can be disposed in control subsystem 904. In alternate embodiments, the one or more transducers 930 are fixed in place and do not rotate. In which case, the driveshaft 928 may, instead, rotate a mirror that reflects acoustic signals to and from the fixed one or more transducers 930.

When the one or more transducers 930 are rotated about the longitudinal axis of the catheter 902 emitting acoustic pulses, a plurality of images can be formed that collectively form a radial cross-sectional image (e.g., a tomographic image) of a portion of the region surrounding the one or more transducers 930, such as the walls of a blood vessel of interest and tissue surrounding the blood vessel. The radial cross-sectional image can form the basis of IVUS image frames 122 and can optionally be displayed on display 116. The at least one of the imaging core 924 can be either manually rotated or rotated using a computer-controlled mechanism.

The imaging core 924 may also move longitudinally along the blood vessel within which the catheter 902 is inserted so that a plurality of cross-sectional images may be formed along a longitudinal length of the blood vessel. During an imaging procedure the one or more transducers 930 may be retracted (e.g., pulled back) along the longitudinal length of the catheter 902. The catheter 902 can include at least one telescoping section that can be retracted during pullback of the one or more transducers 930. In some instances, the drive unit 906 drives the pullback of the imaging core 924 within the catheter 902. The drive unit 906 pullback distance of the imaging core can be any suitable distance including, for example, at least 5 cm, 10 cm, 15 cm, 20 cm, 25 cm, or more. The entire catheter 902 can be retracted during an imaging procedure either with or without the imaging core 924 moving longitudinally independently of the catheter 902.

A stepper motor may, optionally, be used to pull back the imaging core 924. The stepper motor can pull back the imaging core 924 a short distance and stop long enough for the one or more transducers 930 to capture an image or series of images before pulling back the imaging core 924 another short distance and again capturing another image or series of images, and so on.

The quality of an image produced at different depths from the one or more transducers 930 may be affected by one or more factors including, for example, bandwidth, transducer focus, beam pattern, as well as the frequency of the acoustic pulse. The frequency of the acoustic pulse output from the one or more transducers 930 may also affect the penetration depth of the acoustic pulse output from the one or more transducers 930. In general, as the frequency of an acoustic pulse is lowered, the depth of the penetration of the acoustic pulse within patient tissue increases. In some instances, the intravascular treatment system 900 operates within a frequency range of 5 MHz to 900 MHz.

One or more conductors 932 can electrically couple the transducers 930 to the control subsystem 904. In which case, the one or more conductors 932 may extend along a longitudinal length of the rotatable driveshaft 928.

The catheter 902 with one or more transducers 930 mounted to the distal end 916 of the imaging core 924 may be inserted percutaneously into a patient via an accessible blood vessel, such as the femoral artery, femoral vein, or jugular vein, at a site remote from the selected portion of the selected region, such as a blood vessel, to be imaged. The catheter 902 may then be advanced through the blood vessels of the patient to the selected imaging site, such as a portion of a selected blood vessel.

An image or image frame (“frame”) can be generated each time one or more acoustic signals are output to surrounding tissue and one or more corresponding echo signals are received by the imaging device 926 and transmitted to the processor 110 of the computing device 104. Alternatively, an image or image frame can be a composite of scan lines from a full or partial rotation of the imaging core or device. A plurality (e.g., a sequence) of frames may be acquired over time during any type of movement of the imaging device 926. For example, the frames can be acquired during rotation and pullback of the imaging device 926 along the target imaging location. It will be understood that frames may be acquired both with or without rotation and with or without pullback of the imaging device 926. Moreover, it will be understood that frames may be acquired using other types of movement procedures in addition to, or in lieu of, at least one of rotation or pullback of the imaging device 926.

In some instances, when pullback is performed, the pullback may be at a constant rate, thus providing a tool for potential applications able to compute longitudinal vessel/plaque measurements. In some instances, the imaging device 926 is pulled back at a constant rate of about 0.3-0.9 mm/s or about 0.5-0.8 mm/s. In some instances, the imaging device 926 is pulled back at a constant rate of at least 0.3 mm/s. In some instances, the imaging device 926 is pulled back at a constant rate of at least 0.4 mm/s. In some instances, the imaging device 926 is pulled back at a constant rate of at least 0.5 mm/s. In some instances, the imaging device 926 is pulled back at a constant rate of at least 0.6 mm/s. In some instances, the imaging device 926 is pulled back at a constant rate of at least 0.7 mm/s. In some instances, the imaging device 926 is pulled back at a constant rate of at least 0.8 mm/s.

In some instances, the one or more acoustic signals are output to surrounding tissue at constant intervals of time. In some instances, the one or more corresponding echo signals are received by the imaging device 926 and transmitted to the processor 110 of the computing device 104 at constant intervals of time. In some instances, the resulting frames are generated at constant intervals of time.

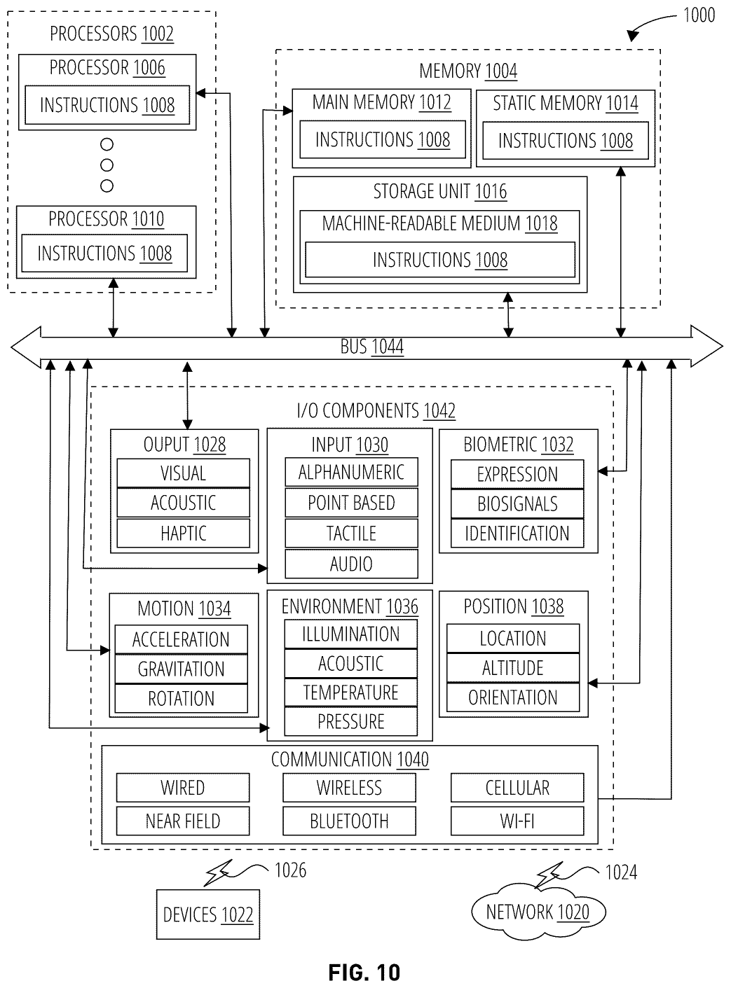

FIG. 10 illustrates a diagrammatic representation of a machine 1000 in the form of a computer system within which a set of instructions may be executed for causing the machine to perform any one or more of the methodologies discussed herein. More specifically, FIG. 10 shows a diagrammatic representation of the machine 1000 in the example form of a computer system, within which instructions 1008 (e.g., software, a program, an application, an applet, an app, or other executable code) for causing the machine 1000 to perform any one or more of the methodologies discussed herein may be executed. For example, the instructions 1008 may cause the machine 1000 to execute instructions 120, routine 200 of FIG. 2, training algorithm 716, or the like. More generally, the instructions 1008 may cause the machine 1000 to generate a 3D model or a vessel physiology from a single angiogram, a series of IVUS images, and vessel pressure measurements as described herein.

The instructions 1008 transform the general, non-programmed machine 1000 into a particular machine 1000 programmed to carry out the described and illustrated functions in a specific manner. In alternative embodiments, the machine 1000 operates as a standalone device or may be coupled (e.g., networked) to other machines. In a networked deployment, the machine 1000 may operate in the capacity of a server machine or a client machine in a server-client network environment, or as a peer machine in a peer-to-peer (or distributed) network environment. The machine 1000 may comprise, but not be limited to, a server computer, a client computer, a personal computer (PC), a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1008, sequentially or otherwise, that specify actions to be taken by the machine 1000. Further, while only a single machine 1000 is illustrated, the term “machine” shall also be taken to include a collection of machines 200 that individually or jointly execute the instructions 1008 to perform any one or more of the methodologies discussed herein.

The machine 1000 may include processors 1002, memory 1004, and I/O components 1042, which may be configured to communicate with each other such as via a bus 1044. In an example embodiment, the processors 1002 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 1006 and a processor 1010 that may execute the instructions 1008. The term “processor” is intended to include multi-core processors that may comprise two or more independent processors (sometimes referred to as “cores”) that may execute instructions contemporaneously. Although FIG. 10 shows multiple processors 1002, the machine 1000 may include a single processor with a single core, a single processor with multiple cores (e.g., a multi-core processor), multiple processors with a single core, multiple processors with multiples cores, or any combination thereof.

The memory 1004 may include a main memory 1012, a static memory 1014, and a storage unit 1016, both accessible to the processors 1002 such as via the bus 1044. The main memory 1004, the static memory 1014, and storage unit 1016 store the instructions 1008 embodying any one or more of the methodologies or functions described herein. The instructions 1008 may also reside, completely or partially, within the main memory 1012, within the static memory 1014, within machine-readable medium 1018 within the storage unit 1016, within at least one of the processors 1002 (e.g., within the processor's cache memory), or any suitable combination thereof, during execution thereof by the machine 1000.

The I/O components 1042 may include a wide variety of components to receive input, provide output, produce output, transmit information, exchange information, capture measurements, and so on. The specific I/O components 1042 that are included in a particular machine will depend on the type of machine. For example, portable machines such as mobile phones will likely include a touch input device or other such input mechanisms, while a headless server machine will likely not include such a touch input device. It will be appreciated that the I/O components 1042 may include many other components that are not shown in FIG. 10. The I/O components 1042 are grouped according to functionality merely for simplifying the following discussion and the grouping is in no way limiting. In various example embodiments, the I/O components 1042 may include output components 1028 and input components 1030. The output components 1028 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1030 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 1042 may include biometric components 1032, motion components 1034, environmental components 1036, or position components 1038, among a wide array of other components. For example, the biometric components 1032 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 1034 may include acceleration sensor components (e.g., accelerometer), gravitation sensor components, rotation sensor components (e.g., gyroscope), and so forth. The environmental components 1036 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 1038 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1042 may include communication components 1040 operable to couple the machine 1000 to a network 1020 or devices 1022 via a coupling 1024 and a coupling 1026, respectively. For example, the communication components 1040 may include a network interface component or another suitable device to interface with the network 1020. In further examples, the communication components 1040 may include wired communication components, wireless communication components, cellular communication components, Near Field Communication (NFC) components, Bluetooth© components (e.g., Bluetooth® Low Energy), Wi-Fi® components, and other communication components to provide communication via other modalities. The devices 1022 may be another machine or any of a wide variety of peripheral devices (e.g., a peripheral device coupled via a USB).

Moreover, the communication components 1040 may detect identifiers or include components operable to detect identifiers. For example, the communication components 1040 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1040, such as location via Internet Protocol (IP) geolocation, location via Wi-Fi® signal triangulation, location via detecting an NFC beacon signal that may indicate a particular location, and so forth.

The various memories (i.e., memory 1004, main memory 1012, static memory 1014, and/or memory of the processors 1002) and/or storage unit 1016 may store one or more sets of instructions and data structures (e.g., software) embodying or utilized by any one or more of the methodologies or functions described herein. These instructions (e.g., the instructions 1008), when executed by processors 1002, cause various operations to implement the disclosed embodiments.

As used herein, the terms “machine-storage medium,” “device-storage medium,” “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various example embodiments, one or more portions of the network 1020 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 1020 or a portion of the network 1020 may include a wireless or cellular network, and the coupling 1024 may be a Code Division Multiple Access (CDMA) connection, a Global System for Mobile communications (GSM) connection, or another type of cellular or wireless coupling. In this example, the coupling 1024 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 1008 may be transmitted or received over the network 1020 using a transmission medium via a network interface device (e.g., a network interface component included in the communication components 1040) and utilizing any one of several well-known transfer protocols (e.g., hypertext transfer protocol (HTTP)). Similarly, the instructions 1008 may be transmitted or received using a transmission medium via the coupling 1026 (e.g., a peer-to-peer coupling) to the devices 1022. The terms “transmission medium” and “signal medium” mean the same thing and may be used interchangeably in this disclosure. The terms “transmission medium” and “signal medium” shall be taken to include any intangible medium that can store, encoding, or carrying the instructions 1008 for execution by the machine 1000, and includes digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a matter as to encode information in the signal.

Terms used herein should be accorded their ordinary meaning in the relevant arts, or the meaning indicated by their use in context, but if an express definition is provided, that meaning controls.

Herein, references to “one embodiment” or “an embodiment” do not necessarily refer to the same embodiment, although they may. Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively, unless expressly limited to one or multiple ones. Additionally, the words “herein,” “above,” “below” and words of similar import, when used in this application, refer to this application as a whole and not to any portions of this application. When the claims use the word “or” in reference to a list of two or more items, that word covers all the following interpretations of the word: any of the items in the list, all the items in the list and any combination of the items in the list, unless expressly limited to one or the other. Any terms not expressly defined herein have their conventional meaning as commonly understood by those having skill in the relevant art(s).

What is claimed is:

1. A method for self-registering a series of IVUS image frames, comprising:
receiving, at the computing device from an intravascular imaging device, a plurality of images associated with a vessel of a patient, the plurality of images comprising multidimensional and multivariate images;
generating, by the computing device for each of the plurality of images, a mask comprising indications of key features of the vessel; and
aligning, by the computing device, the plurality of images based on the plurality of masks.

2. The method of claim 1, wherein the key features comprise at least one of a vessel border, a lumen border, plaque, or a lesion.

3. The method of claim 2, further comprising:
detecting, by the computing device, the vessel border and the lumen border;
inferring, by the computing device using a machine learning (ML) model, the plaque or the lesion; and
generating the mask comprising indications of the detected vessel border, the detected lumen border, and the inferred plaque or lesion.

4. The method of claim 2, further comprising inferring, by the computing device using a machine learning (ML) model, the plurality of masks from the plurality of images.

5. The method of any one of claim 1 to claim 4, wherein aligning the plurality of images based on the plurality of masks comprises:
deriving, for each of the plurality of images, a frame alignment parameter; and
resampling, by the computing device, the plurality of image frames based on the frame alignment parameters.

6. The method of any one of claim 1 to claim 5, further comprising generating, by the computing device, a vessel volume from the aligned plurality of images.

7. The method of claim 6, further comprising:
determining, by the computing device for each voxel of the vessel volume, a color based on the key features; and
rendering, by the computing device, a three-dimensional (3D) visualization of the vessel volume using the determined colors.

8. The method of claim 7, wherein the key features include at least vessel borders, calcified plaque, uncalcified plaque, lumen borders and a stent and wherein each of the key features are associated with a different color.

9. The method of claim 8, wherein the vessel borders are associated with a brown color, calcified plaque is associated with a gray color, uncalcified plaque is associated with a yellow color, lumen borders are associated with a transparent color, and a stent is associated with a white color.

10. The method of any one of claim 7 to claim 9, further comprising displaying the rendered 3D visualization of the vessel volume on a display.

11. The method of any one of claim 7 to claim 10, wherein the 3D visualization comprising a longitudinal view of the vessel and an on-axis view of the vessel.

12. The method of any one of claim 7 to claim 11, wherein the 3D visualization comprises a fly-through of the vessel.

13. A computer-readable storage device, comprising instructions executable by a processor of a computing device coupled to an intravascular imaging device and a fluoroscope device, wherein when executed the instructions cause the computing device to:
receive, from an intravascular imaging device, a plurality of images associated with a vessel of a patient, the plurality of images comprising multidimensional and multivariate images;
generate, for each of the plurality of images, a mask comprising indications of key features of the vessel; and
align the plurality of images based on the plurality of masks.

14. The computer-readable storage device of claim 13, wherein the key features comprise at least one of a vessel border, a lumen border, plaque, or a lesion.

15. The computer-readable storage device of claim 14, the instructions when executed by the processor further cause the computing device to:
detect the vessel border and the lumen border;
infer, using a machine learning (ML) model, the plaque or the lesion; and
generate the mask comprising indications of the detected vessel border, the detected lumen border, and the inferred plaque or lesion.

16. The computer-readable storage device of claim 14, the instructions when executed by the processor further cause the computing device to infer, using a machine learning (ML) model, the plurality of masks from the plurality of images.

17. An apparatus comprising:
a processor arranged to be coupled to an intravascular imaging device and a fluoroscope device; and
a memory storage device coupled to the processor, the memory storage device comprising instructions, which when executed by the processor cause the apparatus to:
receive, from an intravascular imaging device, a plurality of images associated with a vessel of a patient, the plurality of images comprising multidimensional and multivariate images;
generate, for each of the plurality of images, a mask comprising indications of key features of the vessel; and
align the plurality of images based on the plurality of masks.

18. The computer-readable storage device of claim 13, the instructions when executed by the processor further cause the apparatus to:
derive, for each of the plurality of images, a frame alignment parameter;
resample the plurality of image frames based on the frame alignment parameters;
generate a vessel volume from the aligned plurality of images;
determine, for each voxel of the vessel volume, a color based on the key features; and
render a three-dimensional (3D) visualization of the vessel volume using the determined colors.

19. The computer-readable storage device of claim 17, wherein the key features include at least vessel borders, calcified plaque, uncalcified plaque, lumen borders and a stent and wherein each of the key features are associated with a different color.

20. The apparatus of claim 17, wherein the intravascular imaging device is an intravascular ultrasound (IVUS) probe.
